(19) United States
(12) Patent Application Publication
(10) Pub. No.: US 2018/0012383 A1
(43) Pub. Date: Jan. 11, 2018

(54) DISPLAY INFORMATION GENERATION SYSTEM, METHOD, AND COMPUTER PROGRAM PRODUCT

(71) Applicant: Kabushiki Kaisha Toshiba, Minato-ku (JP)

(72) Inventors: Xinxiao LI, Yokohama (JP); Akira KURODA, Yokohama (JP); Hidenori MATSUZAKI, Fuchu (JP)

(73) Assignee: Kabushiki Kaisha Toshiba, Minato-ku (JP)

(21) Appl. No.: 15/442,891

(22) Filed: Feb. 27, 2017

(30) Foreign Application Priority Data
Jul. 6, 2016 (JP) 2016-134188

(51) Int. Cl. G06T 11/20; G06F 3/0484

(52) U.S. Cl. CPC G06T 11/206; G06F 3/04842

(57) ABSTRACT

A display information generation system includes circuitry configured to acquire a record set including a plurality of records respectively representing a correspondence relationship between a plurality of attribute values belonging to attributes different from each other; acquire selected-attribute information identifying a plurality of selected attributes selected from the attributes; acquire display area information about a display area; on the basis of the selected-attribute information and the display area information, extract a plurality of selected attribute values belonging to the selected attributes from the record set, and generate an aggregated-record set including a plurality of aggregated attribute values into which the extracted selected attribute values are aggregated to fit in the display area; and from the aggregated record set, generate display information generating a display image including an aggregation chart representing the correspondence relationship between the selected attributes.

### CROSS-REFERENCE TO RELATED APPLICATIONS

This application is based upon and claims the benefit of priority from Japanese Patent Application No. 2016-134188, filed on Jul. 6, 2016; the entire contents of which are incorporated herein by reference.

### FIELD

Embodiments described herein relate generally to a display information generation system, method, and computer program product.

### BACKGROUND

In various fields, for example, marketing, technological development, or performance analysis, data visualization technology has been used. For example, there is a device making a graph on the basis of time-series numerical data and displaying the graph. The device displays a first graph representing a result of calculation of numerical data collected in an arbitrary period along a time axis, a second graph representing a result of calculation of a first attribute in the period shown in the first graph, and a third graph representing a result of calculation of a second attribute in the period shown in the first graph, and the device updates the second graph and the third graph, according to operation of changing the period in the first graph.

In recent years, data to be visualized has been diversified and increased in size. For visualization of large-scale data, problems tend to occur in visibility or performance. Visibility of detail of data generated by visualization changes depending on features of a display area of a display or the like. For example, when a display image obtained by visualizing entire large-scale data is displayed in a display area having a small size, a display area having a low resolution, or the like, the display image will be in low visibility of detail, and the latency time to render and display the image may also change corresponding to the resolution of the display area. As described above, visibility or latency time of visualizing data to a display image changes depending on the features of the display area.

### BRIEF DESCRIPTION OF THE DRAWINGS

FIG. 1 is a diagram illustrating an example of a hardware configuration of display information generation system according to a first embodiment;

FIG. 2 is a diagram illustrating an example of an internal configuration of an information processing terminal and a server according to the first embodiment;

FIG. 3 is a diagram illustrating an example of a functional configuration of the display information generation system according to the first embodiment;

FIG. 4 is a flowchart illustrating an example of processing performed by the display information generation system according to the first embodiment;

FIG. 5 is a diagram illustrating an example of a record set according to the first embodiment;

FIG. 6 is a diagram illustrating an example of selected-attribute information according to the first embodiment;

FIG. 7 is a diagram illustrating an example of display area information according to the first embodiment;

FIG. 8 is a diagram illustrating an example of an aggregated-record set according to the first embodiment;

FIG. 9 is a diagram illustrating an example of an aggregation chart according to the first embodiment;

FIG. 10 is a diagram illustrating an example of a functional configuration of a display information generation system according to a second embodiment;

FIG. 11 is a diagram illustrating an example of specified attribute values and corresponding attribute values according to the second embodiment;

FIG. 12 is a flowchart illustrating processing performed by a display information generation system according to the second embodiment;

FIG. 13 is a diagram illustrating an example of a display image, and update processing updating the display image, according to the second embodiment;

FIG. 14 is a diagram illustrating an example of a functional configuration of a display information generation system according to a third embodiment;

FIG. 15 is a diagram illustrating an example of a record set according to the third embodiment;

FIG. 16 is a diagram illustrating an example of selected-attribute information according to the third embodiment;

FIG. 17 is a diagram illustrating an example of an extracted-record set according to the third embodiment;

FIG. 18 is a diagram illustrating an example of an aggregated-record set according to the third embodiment;

FIG. 19 is a diagram illustrating an example of a display image, and update processing updating the display image, according to a first example of the third embodiment;

FIG. 20 is a diagram illustrating an example of a display image, and update processing of updating the display image, according to a second example of the third embodiment;

FIG. 21 is a diagram illustrating an example of a record set according to a third example of the third embodiment;

FIG. 22 is a diagram illustrating an example of selected-attribute information according to the third example of the third embodiment;

FIG. 23 is a diagram illustrating an example of a first aggregated-record set according to the third example of the third embodiment;

FIG. 24 is a diagram illustrating an example of a second aggregated-record set according to the third example of the third embodiment;

FIG. 25 is a diagram illustrating an example of a display image, and update processing updating the display image, according to the third example of the third embodiment; and

FIG. 26 is a diagram illustrating an example of a display image, and update processing updating the display image, according to a fourth example of the third embodiment.

### DETAILED DESCRIPTION

### First Embodiment

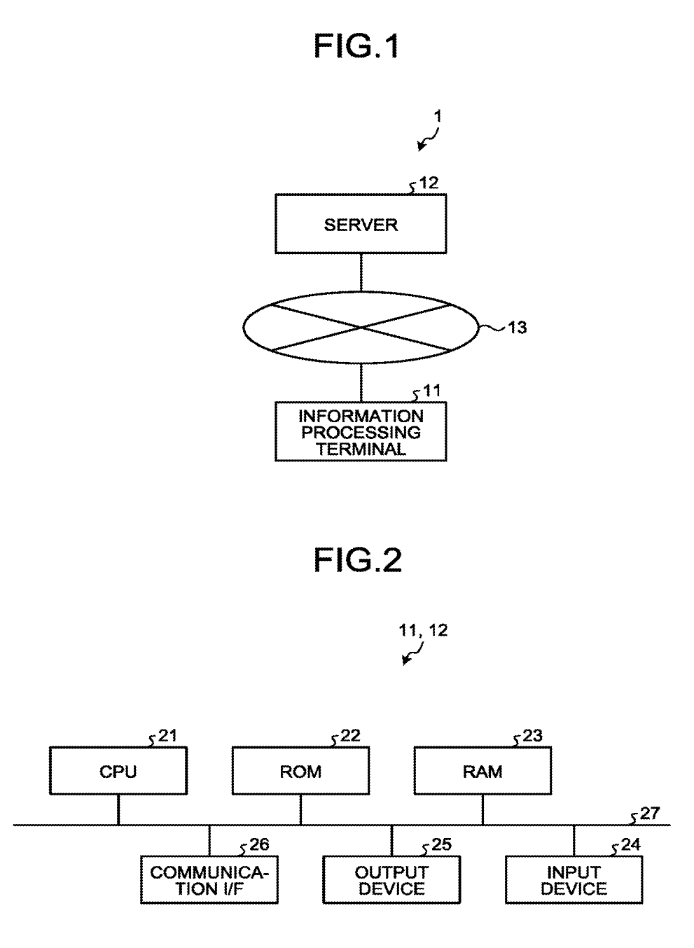

FIG. 1 is a diagram illustrating an example of a hardware configuration of a display information generation system 1 according to a first embodiment. The display information generation system 1 according to the present example includes a display information processing terminal 11, a server 12, and a network 13. The information processing terminal 11 can be a personal computer (PC), a tablet, a smartphone, or the like used by a user. The server 12 can be one or multiple physical computers, a cloud service or the like connected to the information processing terminal 11 shown in the display information generation system 1. The information processing terminal 11 and the server 12 are connected via a connection 13 which may be a display cable, the Internet or a local area network (LAN). Note that, in FIG. 1, one information processing terminal 11 and one server 12 are described, but at least one of the information processing terminal 11 and the server 12 may include a plurality of the information processing terminals 11 and the servers 12.

FIG. 2 is a diagram illustrating an example of an internal configuration of the information processing terminal 11 and the server 12 according to the first embodiment. The information processing terminal 11 and the server 12 each include circuitry such as a central processing unit (CPU) 21, a read only memory (ROM) 22, a random access memory (RAM) 23, an input device 24, an output device 25, a communication I/F (interface) 26, and a bus 27. The CPU 21 performs predetermined calculation processing, according to a control program stored in the ROM 22 or the like, using the RAM 23 as a working area. The input device 24 is a device used to input information from outside, and includes for example a keyboard, a mouse, or a touch panel. The output device 25 is a device used to output information generated inside to the outside, and includes for example a display or a printer. The communication I/F 26 is a device enabling information transmission and reception with an external device through the network. Note that, the server 12 may not include one or both of the input device 24 and the output device 25.

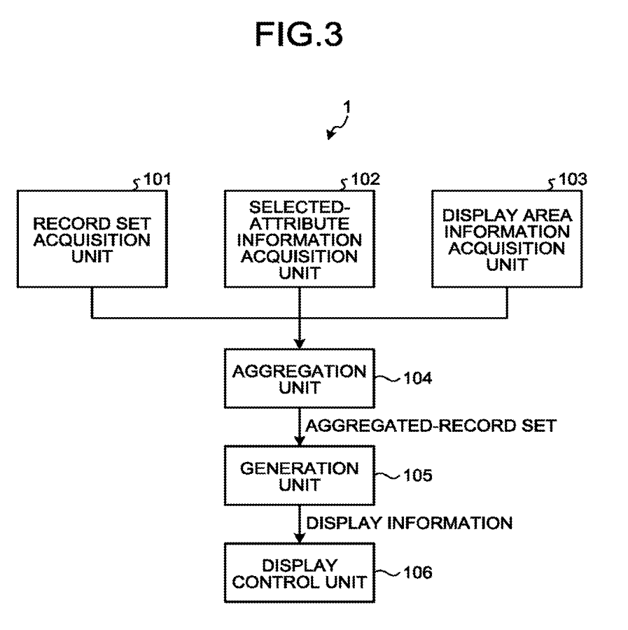

FIG. 3 is a diagram illustrating an example of a functional configuration of the display information generation system 1 according to the first embodiment. The display information generation system 1 includes a record set acquisition unit 101 (first acquisition unit), a selected-attribute information acquisition unit 102 (second acquisition unit), a display area information acquisition unit 103 (third acquisition unit), an aggregation unit 104, and a generation unit 105, and a display control unit 106.

The record set acquisition unit 101 acquires a record set to be visualized by the display information generation system 1. The record set includes a plurality of records. Each of the records is information representing a correspondence relationship between attribute values belonging to different attributes. Each of the attributes represents a kind of data to be visualized. The attribute can be arbitrarily set according to a use condition. A specific example of the attribute includes, for example, time and date, period, place, the number of objects, the number of people, age, money amount, or a value detected by a sensor. Each of the attribute values represents a specific value belonging to each attribute. For example, when the attributes represent “time and date”, “place”, “the number of people”, and “age”, the record serves as information mutually associating a specific value about time and date (“12:00 on Jan. 1, 2016” etc.), a specific value about place (“Tokyo” etc.), a specific value about the number of people (“100 people” etc.), and a specific value about age (“30 years old” etc.), as the attribute values. The record set acquisition unit 101 can be configured to use for example the CPU 21, a control program, the RAM 23, the input device 24, various logic circuits, and the like.

The selected-attribute information acquisition unit 102 acquires selected-attribute information identifying selected attributes which are selected from the attributes. The selected attributes represent attributes required to be visualized in correspondence relationship between the attribute values, and can include, for example, time and date, place, the number of people, age, and the like selected from an attribute group of time and date, period, place, the number of objects, the number of people, age, money amount, and a value detected by a sensor, as described above. The attributes are expected to be selected by the user, or automatically selected in the system. The selected-attribute information acquisition unit 102 can be configured to use for example the CPU 21, a control program, the RAM 23, the input device 24, and various logic circuits.

The display area information acquisition unit 103 acquires display area information about a display area. The display area represents an area in which a display image obtained by visualizing the record set is displayed, and includes for example a display, a printed area of a printed medium, or the like. The display area information represents features of the display area, and can include, for example, the number of pixels, resolution, size, shape, structure, physical properties, or the like. The display area information acquisition unit 103 can be configured to use for example the CPU 21, a control program, the RAM 23, the input device 24, and various logic circuits.

“Acquisition” in the record set acquisition unit 101, the selected-attribute information acquisition unit 102, and the display area information acquisition unit 103 includes reception of external data, generation of internal data, storage of data, or the like. That is, the record set, the selected-attribute information, and the display area information may be generated by a system (device) other than the display information generation system 1, may be input by the user, or may be generated in the display information generation system 1. It should be understood that a method of acquiring the record set, the selected-attribute information, and the display area information is not particularly limited, and the method can include a method appropriately using a known or new technology.

The aggregation unit 104 aggregates the record set on the basis of the selected-attribute information and the display area information, and generates an aggregated-record set. Firstly, the aggregation unit 104 extracts selected attribute values being a plurality of attribute values belonging to the selected attributes selected from the record set, on the basis of the selected-attribute information. Then, the aggregation unit 104 generates an aggregated attribute value into which the extracted, selected attribute values are aggregated to fit in the display area, on the basis of the display area information, and generates the aggregated-record set including a plurality of the aggregated attribute values. An aggregated attribute value can be one value obtained by aggregating the selected attribute values of a selected attribute. Therefore, the number of the aggregated attribute values may be smaller than the number of the selected attribute values. It should be understood that a method of aggregating the selected attribute values to an aggregated attribute value is not particularly limited, as long as an image finally displayed is adapted to features of the display area (the number of pixels, size, or the like). For example, statistic calculation may be performed on a plurality of the selected attribute values so that the selected attribute values are mapped at the same position (coordinates) in a predetermined image to generate one aggregated attribute value from a result of the statistic calculation. A method of the statistic calculation includes, for example, a method of determining an average value, an intermediate value, a maximum value, a minimum value, or the like of the selected attribute values. A mapping method is not limited as long as an image displayed by the mapping method has significance acknowledged by users. The aggregation unit 104 can be configured to use for example the CPU 21, a control program, the RAM 23, and various logic circuits. The aggregation unit 104 may be implemented on the server 12.

The generation unit 105 generates display information generating a display image including an aggregation chart representing a correspondence relationship between the aggregated attribute values, on the basis of the aggregated-record set. The display information can be used for various applications. The display information may be used in the present display information generation system 1, or may be output to another system and used. The generation unit 105 can be configured to use for example the CPU 21, a control program, the RAM 23, various logic circuits, and the like. The generation unit 105 may be implemented on the server 12.

The display control unit 106 controls a display unit to display the display image on the basis of the display information. The display control unit 106 can be configured to use for example the CPU 21, a control program, the RAM 23, and various logic circuits. The display unit includes for example the output device 25 of the information processing terminal 11.

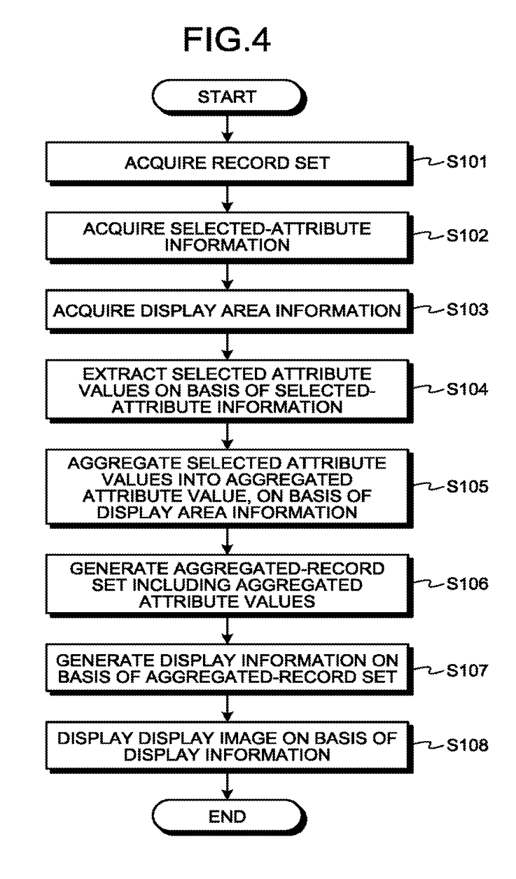

FIG. 4 is a flowchart illustrating an example of processing performed by the display information generation system 1 according to the first embodiment. Firstly, the record set acquisition unit 101 acquires a record set (S101), the selected-attribute information acquisition unit 102 acquires selected-attribute information (S102), and the display area information acquisition unit 103 acquires display area information (S103).

Secondly, the aggregation unit 104 extracts selected attribute values from the record set, on the basis of the selected-attribute information (S104). Next, the aggregation unit 104 aggregates the selected attribute values into an aggregated attribute value, on the basis of the display area information (S105). Then, the aggregation unit 104 generates an aggregated-record set including a plurality of the aggregated attribute values (S106). Thereafter, the generation unit 105 generates display information generating a display image including an aggregation chart, on the basis of the aggregated-record set (S107). Then, the display control unit 106 controls the predetermined display unit so that the display image is displayed on the basis of the display information (S108).

Owing to the above configuration, the aggregated-record set into which the record set is aggregated to fit in the display area is generated, and the display information is generated on the basis of the aggregated-record set. Thus, the display image including the aggregation chart adapted to the display area can be displayed, and even if the record set has a large scale, visibility can be fully ensured according to the features of the display area.

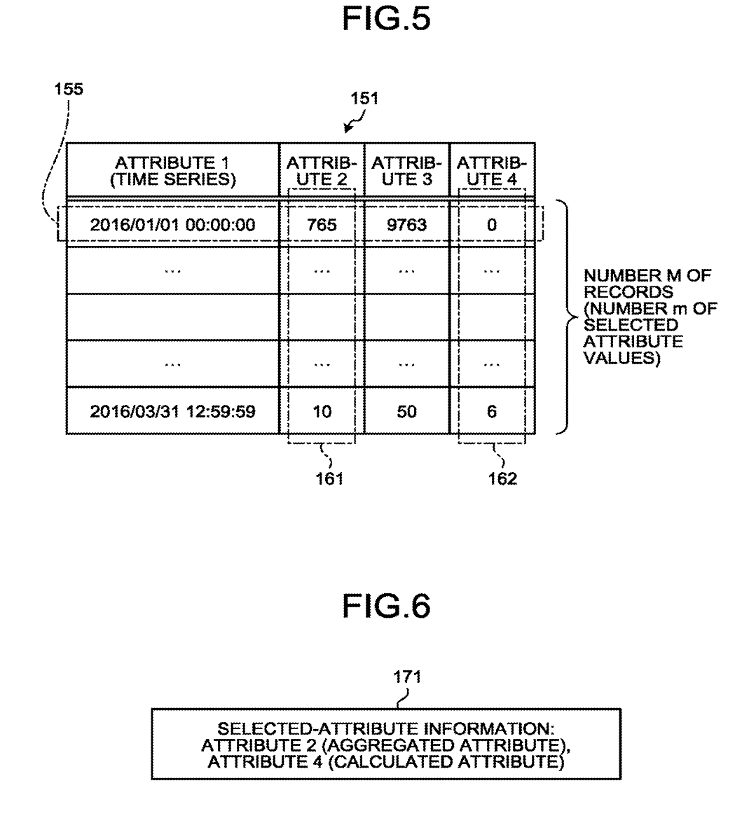

FIG. 5 is a diagram illustrating an example of the record set 151 according to the first embodiment. The record set 151 according to the present example includes a plurality of attribute values belonging to four attributes 1 to 4. The record set 151 includes M records 155, each of the records 155 represents a correspondence relationship between the four attribute values respectively belonging to the attributes 1 to 4. For example, an uppermost record 155 is information associating an attribute value “2016/01/01 00:00:00” belonging to the attribute 1, an attribute value “765” belonging to the attribute 2, an attribute value “9763” belonging to the attribute 3, and an attribute value “0” belonging to the attribute 4, with each other. The other records are also information similarly associating different attribute values with each other. The attributes 1 to 4 are arbitrarily set as described above. The attribute 1 according to the present example represents time and date (time-series).

FIG. 6 is a diagram illustrating an example of the selected-attribute information 171 according to the first embodiment. The selected-attribute information 171 according to the present example is information identifying the attribute 2 (aggregated attribute) and the attribute 4 (calculated attribute) which are two selected attributes selected from four attributes 1 to 4. The attribute 2 is an attribute corresponding to a horizontal axis of the aggregation chart described later, and the attribute 4 is an attribute corresponding to a vertical axis. In the present example, a selected attribute corresponding to the horizontal axis is referred to as the aggregated attribute, and a selected attribute corresponding to the vertical axis is referred to as the calculated attribute. FIG. 5 illustrates a plurality of the selected attribute values 161 belonging to the attribute 2, and a plurality of the selected attribute values 162 belonging to the attribute 4. The maximum number of selected attribute values 161 or 162 (the number m of selected attribute values) is coincide with the number of records 155 (the number M of records).

The selected attribute values 161 and are uses as data making a chart visualizing a correspondence relationship between the selected attributes 2 and 4. When the number m of selected attribute values is enormous, use of the entire selected attribute values 161 and 162 as data making the chart may cause a problem of visibility. Thus, in the present embodiment, processing for aggregating the selected attribute values 161 and 162 to fit in the display area, on the basis of the display area information.

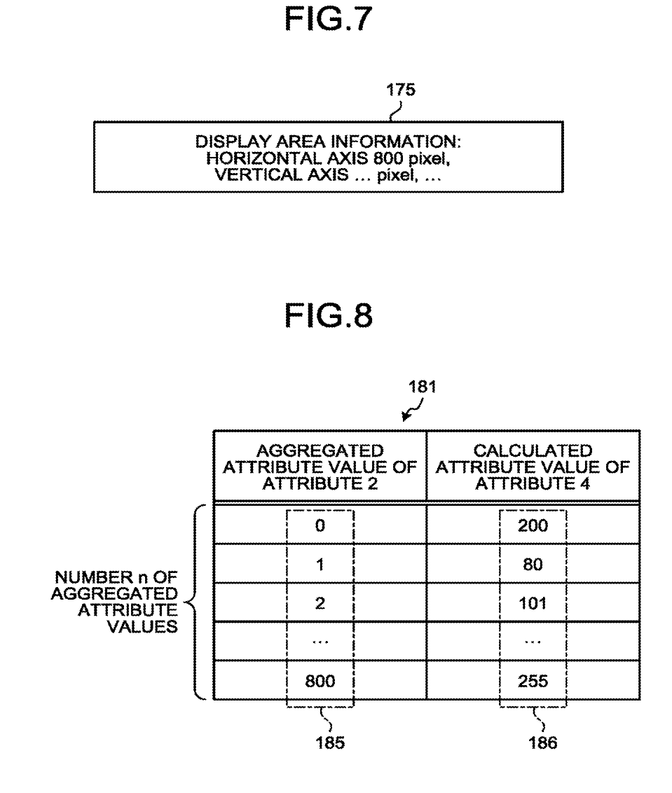

FIG. 7 is a diagram illustrating an example of the display area information 175 according to the first embodiment. The display area information 175 according to the present embodiment includes the number of pixels of a display. The number of pixels on the horizontal axis is 800 pixels, in the present example. The display area information 175 may further include information such as the number of pixels on the vertical axis, the number of pixels on the horizontal axis. Note that the number of pixels included in the display area information 175 is not limited to the number of pixels of the whole display, and may be for example the number of pixels in a view (window) in which the chart is displayed. When the number of pixels in the display area is used to aggregate data, values included in the display area information 175 are changed according to the change in the number of pixels in the display area. The same applies to the horizontal axis and the vertical axis if necessary for a certain chart. A configuration of the display area information 175 is to be appropriately designed according to a use condition or the like. In the current example, the number of pixels along horizontal axis in the display area is used to aggregate data.

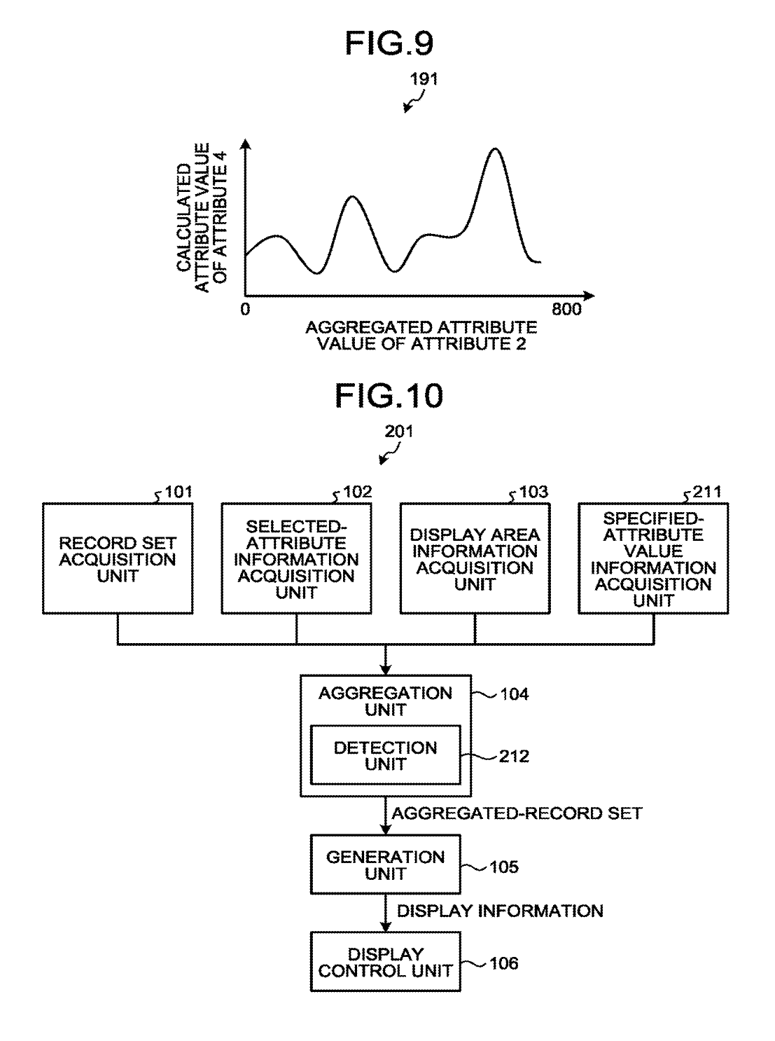

FIG. 8 is a diagram illustrating an example of the aggregated-record set 181 according to the first embodiment. FIG. 9 is a diagram illustrating an example of the aggregation chart 191 according to the first embodiment. The aggregation chart 191 is a chart generated on the basis of the aggregated-record set 181.

The aggregated-record set 181 illustrated in FIG. 6 includes the aggregated attribute values 185 corresponding to the attribute 2 (aggregated attribute), and calculated attribute values 186 corresponding to the attribute 4 (calculated attribute). Here, an attribute value corresponding to the horizontal axis of the aggregation chart 191 is referred to as an aggregated attribute value, and an attribute value corresponding to the vertical axis is referred to as a calculated attribute value. The aggregated attribute values 185 are values obtained by aggregating the selected attribute values 161 converted to coordinate values (0 to 800) on the horizontal axis. The calculated attribute values 186 are values obtained by calculating statistic from the selected attribute values 162 subjected to averaging or the like to correspond to the aggregated attribute values 185. The aggregated attribute values 185 and the calculated attribute values 186 are information obtained from the selected attribute values 161 and 162, which are identified on the basis of the selected-attribute information 171, to fit in the display area on the basis of the display area information 175, respectively.

The number of the aggregated attribute values 185 according to the present embodiment (the number n of the aggregated attribute values) is determined according to the number of pixels on the horizontal axis. The number n of the aggregated attribute values is preferably the number of pixels, but is not limited thereto. The number n of the aggregated attribute values may have a value equal or a little larger than the number of pixels in order to ensure sufficient visibility of detail in actual application cases. As described above, since the number n of the aggregated attribute values is determined by the number of pixels in the display area, an improvement processing speed can be achieved by aggregating to reduce the number of data to be displayed.

A calculated attribute value 186 according to the present embodiment is obtained by statistically calculating the selected attribute values 162 corresponding to the attribute 4. The number of the calculated attribute values 186 according to the present example has a value the same as the number n of the aggregated attribute values 185. One calculated attribute value 186 has a value obtained by aggregating a plurality of the selected attribute values 162. The one calculated attribute value 186 may be for example an average value, an intermediate value, a maximum value, a minimum value of the selected attribute values 162.

The number of aggregated attribute values 185 or calculated attribute values 186 (the number n of the aggregated attribute values) are supposed to be much less than the number m of selected attribute values. That is, is a natural number larger than 1, and n is a natural number much less than m.

As described above, according to the display information generation system 1 of the first embodiment, the pluralities of selected attribute values 161 and 162 are aggregated into the aggregated attribute values 185 and the calculated attribute values 186, respectively, to be fit in the display area, and the aggregated-record set 181 is generated, including the aggregated attribute values 185 and the calculated attribute values 186. The display information generating the aggregation chart 191 is generated, on the basis of the aggregated-record set 181. Thus, even if the record set 151 has a large scale, the aggregation chart 191 can be displayed to be adapted to the display area, and visibility of detail is kept or performance can be improved.

Note that the hardware configurations illustrated in FIGS. 1 and 2 are provided by way of examples, and the display information generation system 1 can be achieved by various hardware configurations. For example, the display information generation system 1 may be configured by a single general-purpose computer, a dedicated device having an embedded processor, a cloud service or the like.

FIG. 3 illustrates the configuration in which basic functional blocks of the display information generation system 1 are connected in the order of the processing, but the embodiment is not limited to this configuration. For example, the configuration may employ a configuration in which the functional blocks are laterally operated in cooperation with each other, a configuration in which the arrangement order of the functional blocks is changed, a configuration in which one functional block is divided into a plurality of functional blocks, a configuration in which these three configurations are combined.

A control program achieving function of the display information generation system 1 can be provided to be recorded in a computer-readable recording medium, such as CD-ROM, flexible disk (FD), CD-R, or DVD, in an installable or executable file format. Furthermore, the control program may be provided by being downloaded from a predetermined storage device connected to the network to a predetermined computer, or may be previously installed on the ROM or the like to be provided to a predetermined information processing device. Furthermore, the control program may be constituted by a plurality of modules at least partially performing function of functional units illustrated in FIG. 3.

In the following, description will be given of other embodiments with reference to the drawings, but portions having functional effects the same as or similar to those in the first embodiment are denoted by the same reference signs, and description thereof may be omitted.

### Second Embodiment

FIG. 10 is a diagram illustrating an example of a functional configuration of a display information generation system 201 according to a second embodiment. The display information generation system 201 according to the present embodiment includes a unit updating the aggregated-record set 181 on the basis of a specified condition. The display information generation system 201 according to the present embodiment includes a specified-attribute value information acquisition unit 211 (fourth acquisition unit) and a detection unit 212, in addition to the configuration of the display information generation system 1 according to the first embodiment illustrated in FIG. 3.

The specified-attribute value information acquisition unit 211 acquires specified-attribute value information identifying specified attribute values specified from a plurality of attribute values. The specified attribute values represent attribute values used to narrow down a display range of the aggregation chart 191. The specified attribute values can have various values, for example, it may specify a range of the selected attribute, or attribute values specifying one or multiple groups of the selected attribute. The specified attribute values may be specified by the user, or may be specified automatically in the system on the basis of a predetermined condition. The specified-attribute value information acquisition unit 211 can be configured to use for example the CPU 21, a control program, the RAM 23, the input device 24, and various logic circuits.

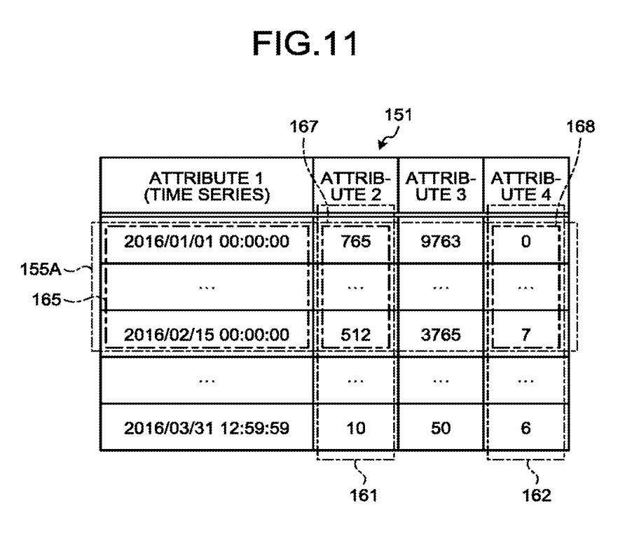

The detection unit 212 detects corresponding attribute values corresponding to the specified attribute values from among the plurality of attribute values included in the record set 151 on the basis of the specified-attribute value information. FIG. 11 is a diagram illustrating an example of the specified attribute values 165 and the corresponding attribute values 167 and 168 according to the second embodiment. The detection unit 212 identifies the specified attribute values 165 in the record set 151 on the basis of the specified-attribute value information, and detects the corresponding attribute values 167 and 168 as the selected attribute values 161 and 162 included in records 155A including the specified attribute values 165. The detection unit 212 can be configured to use for example the CPU 21, a control program, the RAM 23, and various logic circuits.

The aggregation unit 104 according to the second embodiment aggregates the corresponding attribute values 167 and 168 to fit in the display area, on the basis of the display area information 175, and generates the aggregated-record set 181 including the aggregated corresponding attribute values 167 and 168. Aggregation processing of the corresponding attribute values 167 and 168 in the second embodiment can be performed similarly to the aggregation processing of the selected attribute values 161 and 162 in the first embodiment described above. For example, the corresponding attribute values 167 are converted to coordinate values (0 to 800) on a horizontal axis, and the corresponding attribute values 168 are subjected to averaging or the like to correspond to the corresponding attribute values 167. Therefore, the aggregated-record set 181 is updated according to the specified attribute values 165, and the aggregation chart 191 is updated.

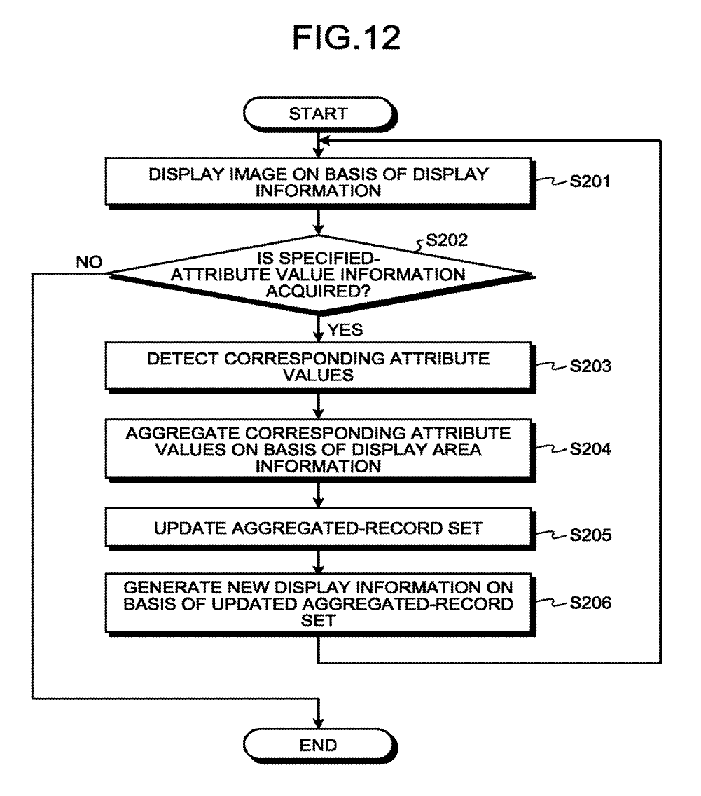

FIG. 12 is a flowchart illustrating processing performed by the display information generation system 201 according to the second embodiment. Firstly, the display control unit 106 controls the predetermined display unit so that the display image is displayed on the basis of the display information (S201). For example, step S201 is performed through processing similar to that of steps S101 to S108 according to the first embodiment of FIG. 4.

Then, it is determined whether the specified-attribute value information acquisition unit 211 acquires the specified-attribute value information (S202). When the specified-attribute value information acquisition unit 211 does not acquire the specified-attribute value information (S202: No), this routine is finished. That is, the display image displayed in step S201 is entirely displayed.

In contrast, when the specified-attribute value information acquisition unit 211 acquires the specified-attribute value information (S202: Yes), the detection unit 212 detects the corresponding attribute values 167 and 168 on the basis of the specified-attribute value information (S203). Then, the aggregation unit 104 aggregates the corresponding attribute values 167 and 168, on the basis of the display area information 175 (S204). Thereafter, the aggregation unit 104 updates the aggregated-record set 181 on the basis of new aggregated attribute values 185 and calculated attribute values 186 generated from the aggregation in step S204 (S205). Then, on the basis of the updated aggregated-record set 181, the updated generation unit 105 generates new display information (S206). Thereafter, the display control unit 106 controls the predetermined display unit so that the display image is displayed on the basis of the new display information (S201).

According to the above processing, the display image is updated, when specified-attribute value information is acquired on the basis of direct specification operation event by the user, specification information transfer event from a remote place, or the like after an initial display image is generated in step S201. Note that the specified-attribute value information may be acquired without pre-displayed image generated from the step S201, in which case, the step S201 may be unnecessary.

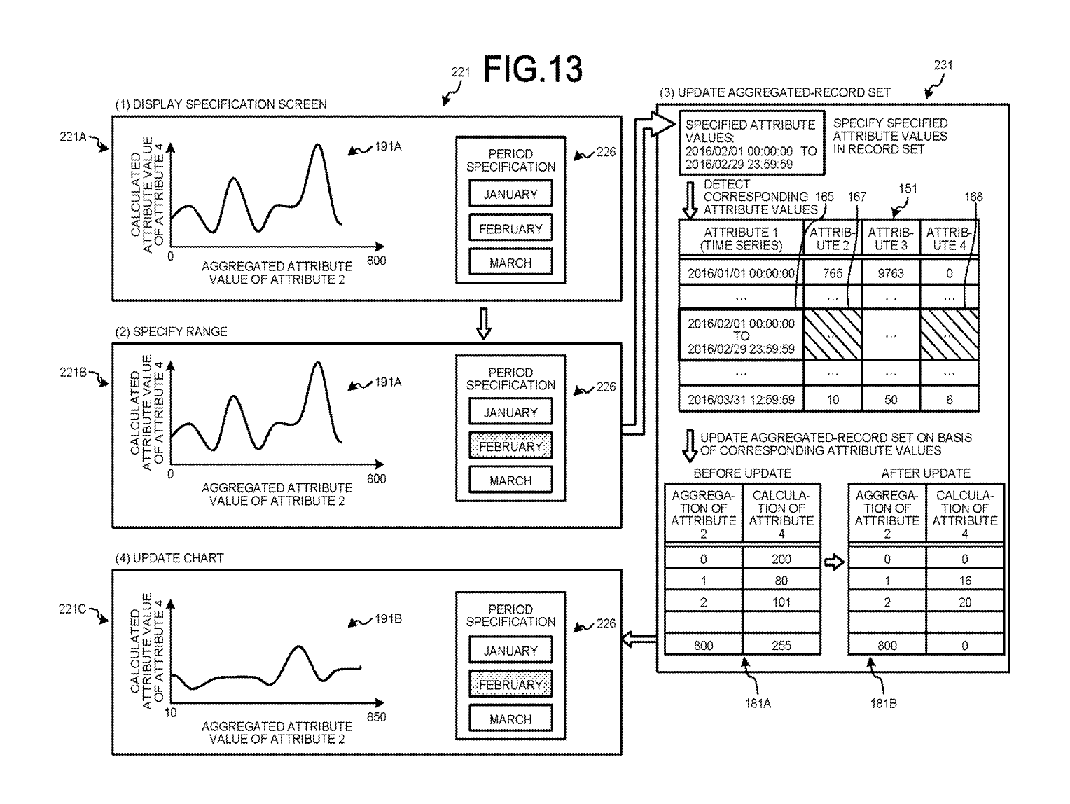

FIG. 13 is a diagram illustrating an example of the display image 221, and update processing 231 updating the display image 221, according to the second embodiment. FIG. 13 illustrates a first display image 221A, a second display image 221B, and a third display image 221C.

The first display image 221A, which includes an aggregation chart 191A, illustrates a state before inputting a filtering condition for filtering information displayed on the aggregation chart 191 (before specifying the specified attribute values 165). The specification object 226 is used as a user interface for inputting a user's desired filtering condition. The specification object 226 according to the present example is configured to specify a desired month from January to March on the display.

The second display image 221B illustrates a state after inputting the filtering condition. In the present example, February is specified in the specification object 226.

The update processing 231 represents an example of internal processing updating the aggregated-record set 181 from which the aggregation chart 191A is generated, on the basis of the filtering condition specified in the second display image 221B. Firstly, in the present example, since February is specified as the filtering condition, attribute values “2016/02/01 00:00:00” to “2016/02/29 23:59:59” belonging to the attribute 1 in the record set 151 is identified as the specified attribute values 165. Secondly, the corresponding attribute values 167 and 168 are detected which are the selected attribute values 161 and 162 included in records 155A including the specified attribute values 165. Then, on the basis of the corresponding attribute values 167 and 168 and the display area information 175, an aggregated-record set 181A before update is updated to an aggregated-record set 181B after update.

The third display image 221C illustrates a state after the aggregation chart 191A is updated, and includes an aggregation chart 191B after update which is generated on the basis of the aggregated-record set 181B after update.

As described above, according to the display information generation system 201 of the second embodiment, specifying the filtering condition allows arbitrary change of the display range of the aggregation chart 191.

### Third Embodiment

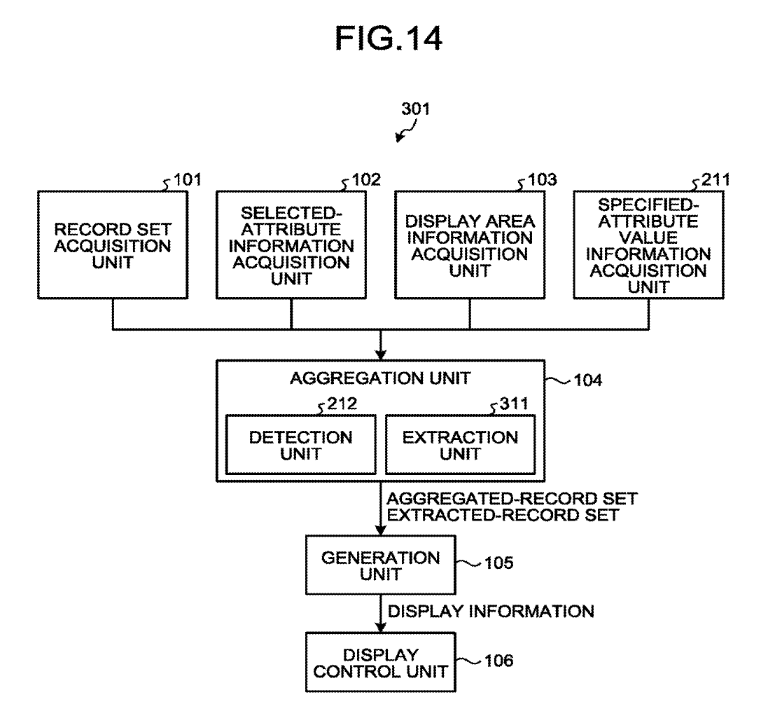

FIG. 14 is a diagram illustrating an example of a functional configuration of a display information generation system 301 according to a third embodiment. The display information generation system 301 is used for cooperation between a plurality of the charts. The display information generation system 301 according to the present embodiment includes an extraction unit 311, in addition to the configuration of the display information generation system 201 according to the second embodiment illustrated in FIG. 10.

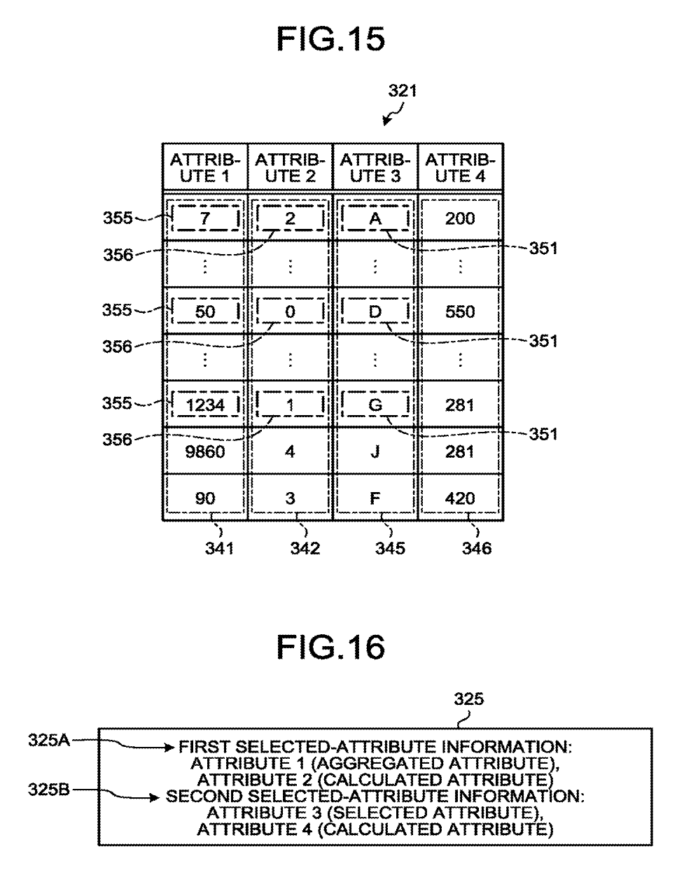

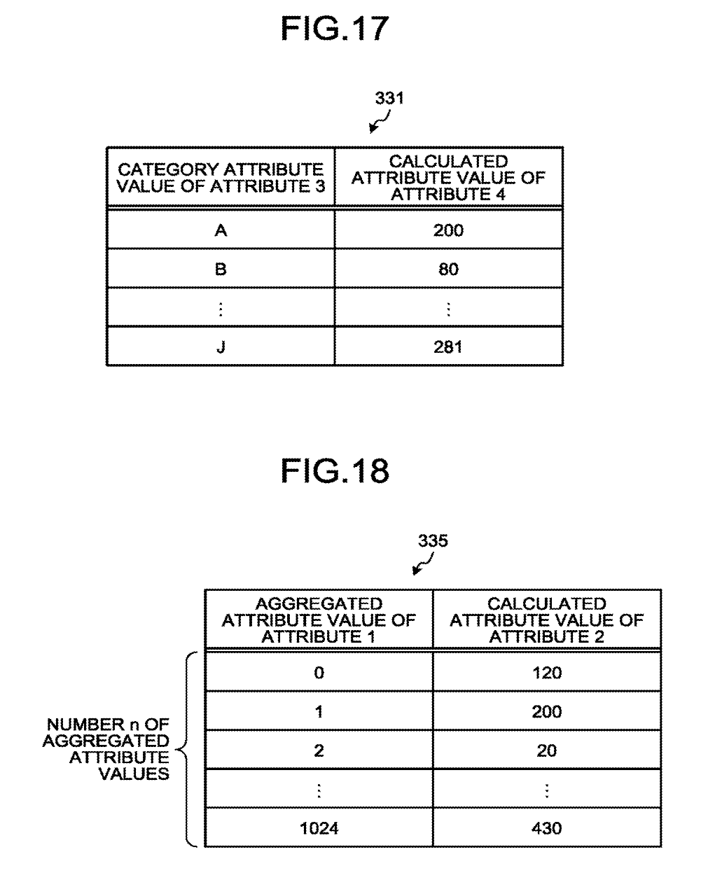

FIG. 15 is a diagram illustrating an example of a record set 321 according to the third embodiment. FIG. 16 is a diagram illustrating an example of selected-attribute information 325 according to the third embodiment. FIG. 17 is a diagram illustrating an example of the extracted-record set 331 according to the third embodiment. FIG. 18 is a diagram illustrating an example of an aggregated-record set 335 according to the third embodiment.

The selected-attribute information 325 according to the present example includes two sets of selected-attribute information 325A and 325B. The first selected-attribute information 325A represents a combination of the attribute 1 (aggregated attribute) and the attribute 2 (calculated attribute). The second selected-attribute information 325B represents a combination of the attribute 3 (category attribute) and the attribute 4 (calculated attribute). The first selected-attribute information 325A is used to generate the aggregated-record set 335 illustrated in FIG. 18. The second selected-attribute information 325B is used to generate the category-record set 331 illustrated in FIG. 17.

The extraction unit 311 extracts, from the record set 321, attribute values 345 and 346 corresponding to the selected category attribute 3 and the selected attribute 4 respectively, on the basis of the second selected-attribute information 325B, and generates the category-record set 331. The extracted-record set 331 illustrated in FIG. 17 includes the category attribute of selected 3 and the calculated attribute values of the selected attribute 4. The extraction unit 311 can be configured to use for example the CPU 21, a control program, the RAM 23, and various logic circuits.

The generation unit 105 according to the present embodiment generates display information so that the extraction chart based on the category-record set 331 is also included in the display image, in addition to the aggregation chart based on the aggregated-record set 335.

The specified-attribute value information acquisition unit 211 according to the present embodiment acquires the specified-attribute value information identifying a specified attribute value 351 through the extraction chart.

The detection unit 212 according to the present embodiment detects corresponding attribute values 355 and 356 corresponding to the specified attribute value 351, on the basis of the specified-attribute value information acquired, and the aggregation unit 104 according to the present embodiment updates the aggregated-record set 335, on the basis of the corresponding attribute values 355 and 356 and the display area information 175. Update of the aggregated-record set 335 can be performed as in the second embodiment.

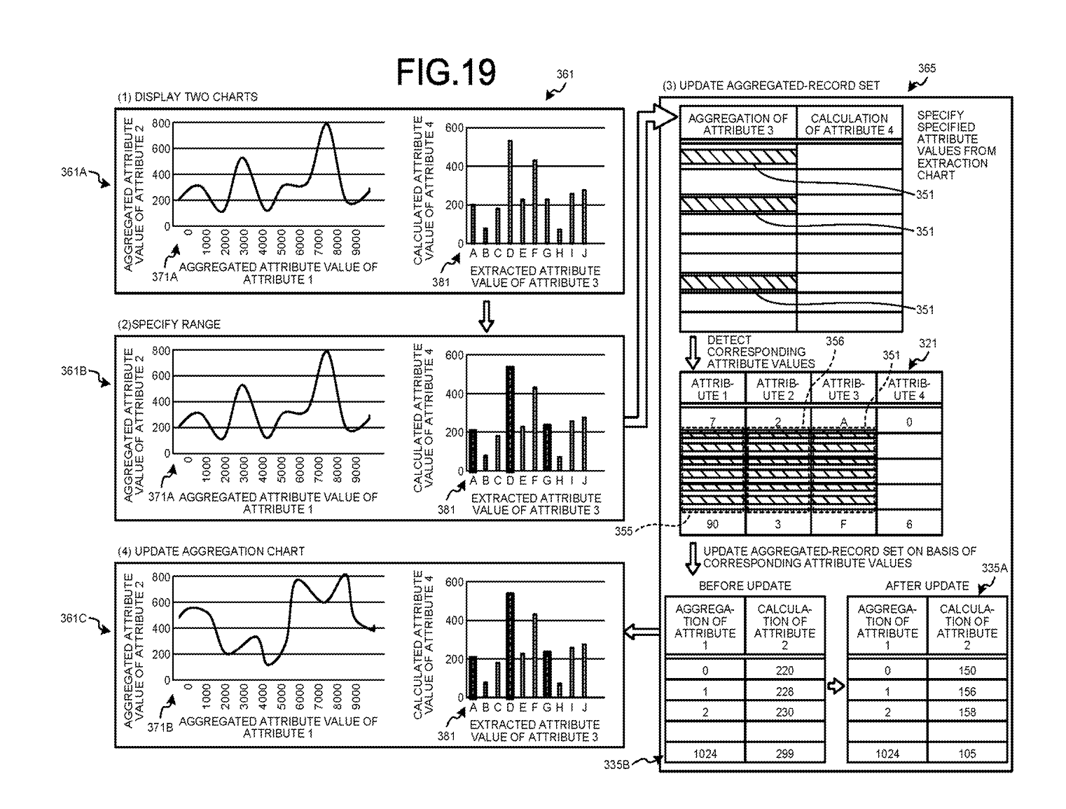

FIG. 19 is a diagram illustrating an example of a display image 361, and update processing 365 updating the display image 361, according to a first example of the third embodiment. FIG. 19 illustrates a first display image 361A, a second display image 361B, and a third display image 361C.

The first display image 361A represents a state before inputting a filtering condition for filtering a display range of an aggregation chart 371A (before specifying a specified attribute value 351). The first display image 361A includes the aggregation chart 371A before update and the extraction chart 381. In the present example, the extraction chart 381 is used as a user interface for inputting a filtering condition.

The second display image 361B illustrates a state after inputting the filtering condition. In the present example, attribute values A, D, and G are specified from the extraction chart 381.

The update processing 365 represents an example of internal processing updating the aggregated-record set 335 from which the aggregation chart 371A is generated, on the basis of the filtering condition specified in the second display image 361B. Firstly, from a specification result in the second display image 361B, attribute values A, D, and G belonging to the attribute 3 are identified as the specified attribute values 351. Secondly, the corresponding attribute values and 356 are detected which are included in the records including the specified attribute values 351, and are selected attribute values 341 and 342 corresponding to the aggregated-record set 335. Then, on the basis of the detected corresponding attribute values 355 and 356 and predetermined display area information, an aggregated-record set 335A before update is updated to an aggregated-record set 335B after update.

The third display image 361C illustrates a state after the aggregation chart 371A is updated, and includes an aggregation chart 371B after update which is generated on the basis of the aggregated-record set 335B after update.

According to the above configuration, the filtering condition is specified, through the bar chart 381 generated on the basis of the category-record set 331 extracted from the record set 321.

Owing to the above configuration, cooperation between the line chart 191 and the bar chart 381 can be achieved. Note that the bar chart 381 may be not necessarily included in the display image, in which case, the specified-attribute value information may be not necessarily acquired through the bar chart 381.

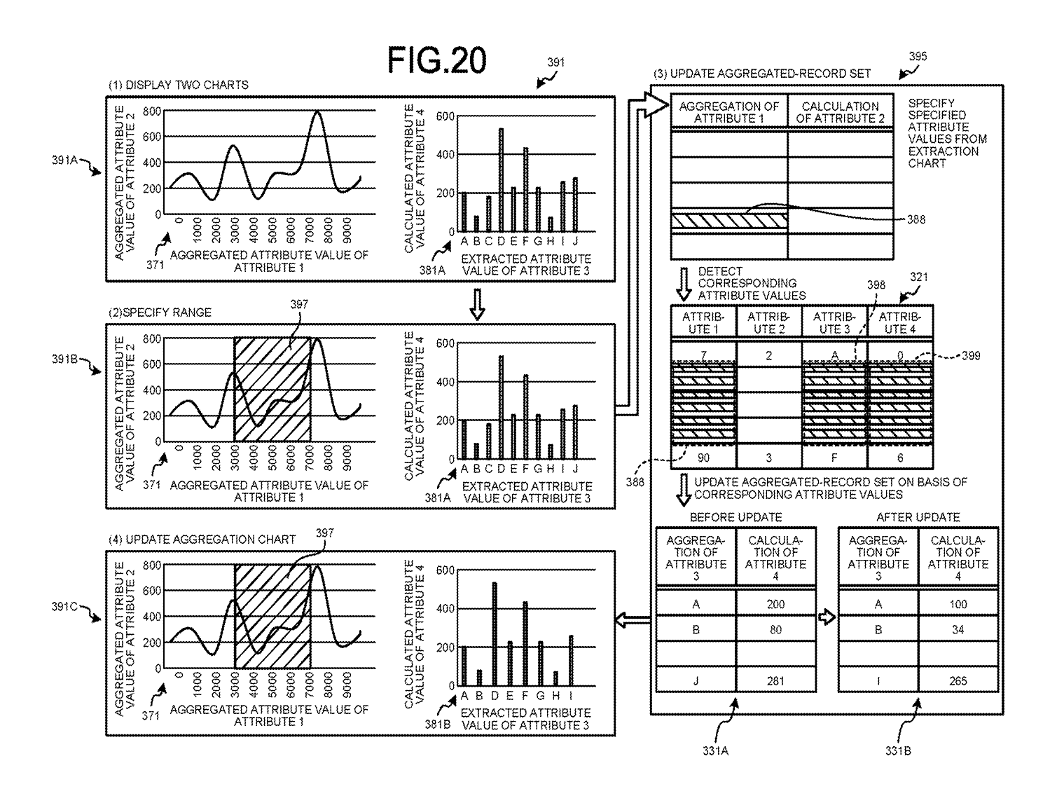

FIG. 20 is a diagram illustrating an example of a display image 391, and update processing 395 updating the display image 391, according to a second example of the third embodiment. In the present example, the filtering condition is specified through an aggregation chart 371, and the extraction chart 381 is updated according to the filtering condition. FIG. 20 illustrates a first display image 391A, a second display image 391B, and a third display image 391C.

The first display image 391A illustrates a state before inputting a filtering condition for filtering a display range of a bar chart 381A. The first display image 391A includes the line chart 371 and the bar chart 381A before update. In the present example, the line chart 371 is used as the user interface for inputting a filtering condition.

The second display image 391B illustrates a state after inputting the filtering condition. In the present example, a desired specification range 397 in the line chart 371 is specified, and partial attribute values (3000 to 7000) belonging to the attribute 1 are specified.

The update processing 395 represents an example of internal processing updating a category-record set 331A from which the bar chart 381A is generated, on the basis of the filtering condition specified in the second display image 391B. Firstly, from a specification result in the second display image 391B, partial attribute values (3000 to 7000) belonging to the attribute 1 are identified as specified attribute values 388. Secondly, corresponding attribute values 398 and 399 are detected which are included in the records including the identified specified attribute values 388, and are the selected attribute values relating to the category-record set 331. Then, on the basis of the corresponding attribute values 398 and 399, the category-record set 331A before update is updated to a category-record set 331B after update.

The third display image 391C illustrates a state after the extraction chart 381A is updated, and includes the bar chart 381B after update which is generated on the basis of the category-record set 331B after update.

As described in the above configuration, filtering information may be specified through the line chart 371 to update the bar chart 381.

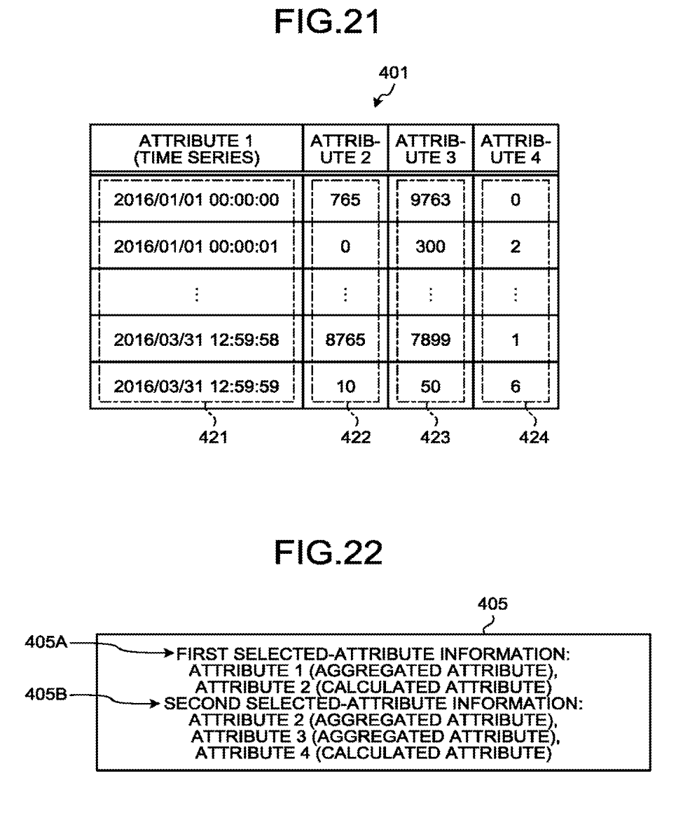

FIG. 21 is a diagram illustrating an example of a record set 401 according to a third example of the third embodiment. FIG. 22 is a diagram illustrating an example of a selected-attribute information 405 according to the third example of the third embodiment. The selected-attribute information 405 according to the present example includes a first selected-attribute information 405A identifying two selected attributes (attribute 1 (aggregated attribute) and attribute (calculated attribute)), and a second selected-attribute information 405B identifying three selected attributes (attribute 2 (aggregated attribute), attribute 3 (aggregate attribute), and attribute 4 (calculated attribute)). FIG. 21 illustrates selected attribute values 421 belonging to the attribute 1, selected attribute values 422 belonging to the attribute 2, selected attribute values 423 belonging to the attribute 3, and selected attribute value 424 belonging to the attribute 4.

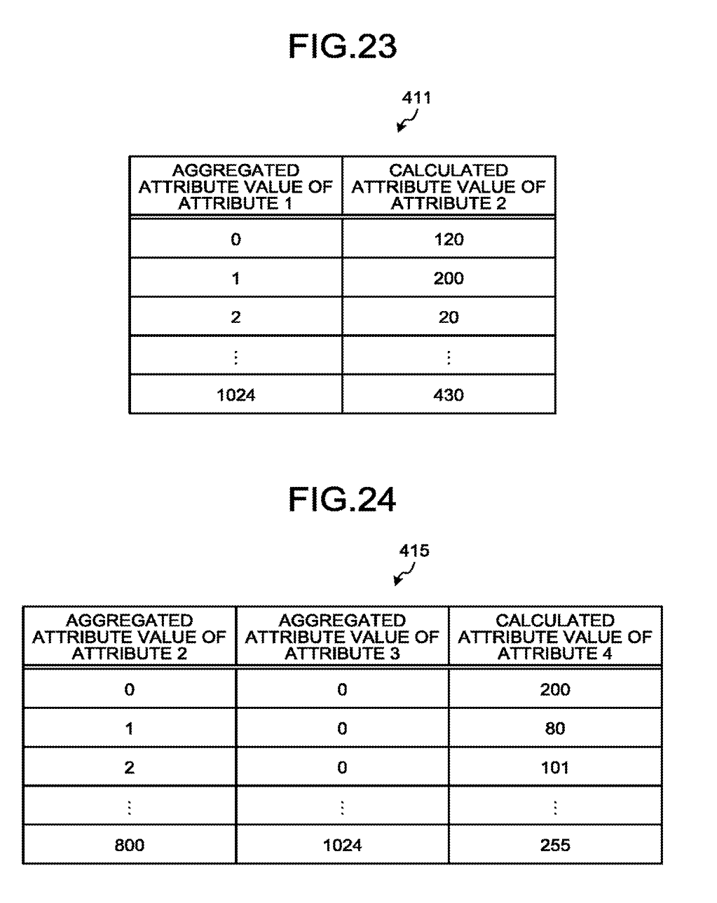

FIG. 23 is a diagram illustrating an example of a first aggregated-record set 411 according to the third example of the third embodiment. FIG. 24 is a diagram illustrating an example of a second aggregated-record set 415 according to the third example of the third embodiment. The first aggregated-record set 411 is generated on the basis of the first selected-attribute information 405A and predetermined display area information. The second aggregated-record set 415 is generated on the basis of the second selected-attribute information 405B and predetermined display area information.

In the present example, on the basis of the two aggregated-record sets 411 and 415, a display image including two aggregation charts is displayed.

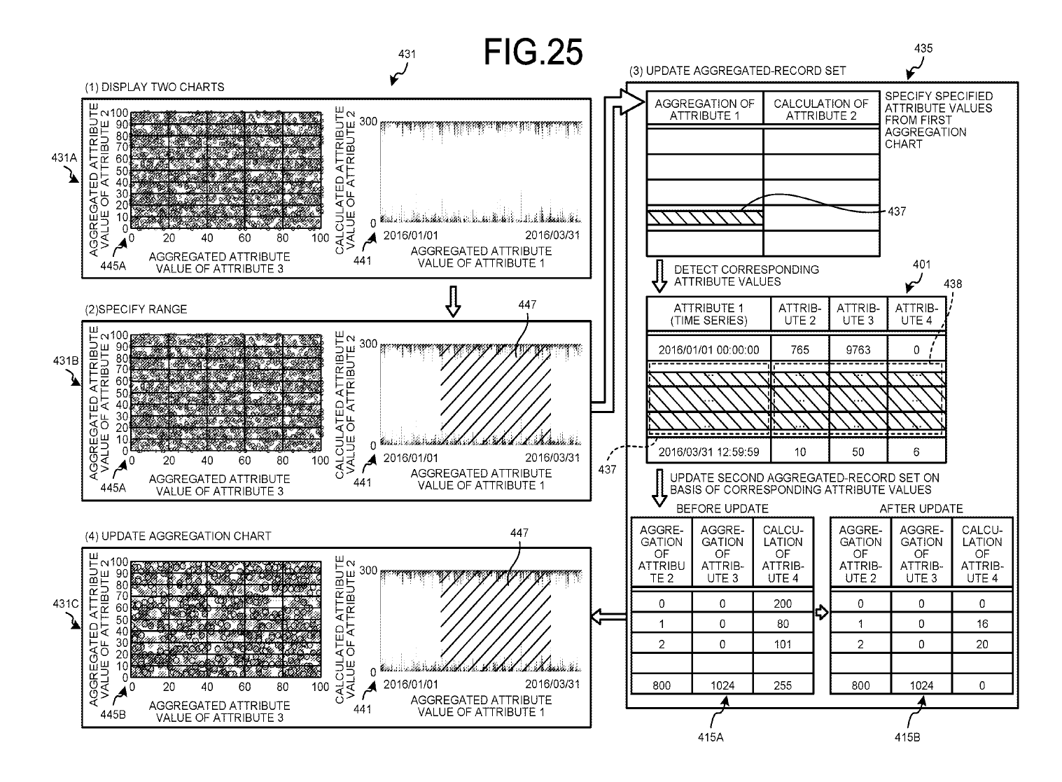

FIG. 25 is a diagram illustrating an example of the display image 431, and update processing 435 updating the display image 431, according to the third example of the third embodiment. The display image 431 includes a first aggregation chart 441 generated on the basis of the first aggregated-record set 411, and second aggregation charts 445A and 445B generated on the basis of the second aggregated-record set 415. The second aggregation charts 445A and 445B according to the present example represents a scatter plot, in which the horizontal axis corresponds to attribute values of the attribute 3, the vertical axis corresponds to attribute values of the attribute 2, and graphic primitives (here are dots with attributes such as color, brightness, size, etc.) correspond to attribute values of the attribute 4. FIG. 25 illustrates a first display image 431A, a second display image 431B, and a third display image 431C.

The first display image 431A illustrates a state before inputting a filtering condition for filtering a display range of the second aggregation chart 445A. The first display image 431A includes the first aggregation chart 441 and the second aggregation chart 445A before update. In the present example, the first aggregation chart 441 is used as the user interface for inputting a filtering condition.

The second display image 431B illustrates a state after inputting the filtering condition. In the present example, a desired specification range 447 in the first aggregation chart 441 is specified, and partial attribute values (2016/02/01 00:00:00 to 2016/02/29 23:59:59) belonging to the attribute 1 are specified.

The update processing 435 represents an example of internal processing updating a second aggregated-record set 415A from which the second aggregation chart 445A is generated, on the basis of the filtering condition specified in the second display image 431B. Firstly, from a specification result in the second display image 431B, the partial attribute values (2016/02/01 00:00:00 to 2016/02/29 23:59:59) belonging to the attribute 1 are identified as the specified attribute values 437. Secondly, corresponding attribute values 438 are detected from the record set 401. Then, on the basis of the corresponding attribute values 438 and predetermined display area information, the second aggregated-record set 415A before update is updated to a second aggregated-record set 415B after update.

The third display image 431C illustrates a state after the second aggregation chart 445A is updated, and includes the second aggregation chart 445B after update which is generated on the basis of the second aggregated-record set 415B after update.

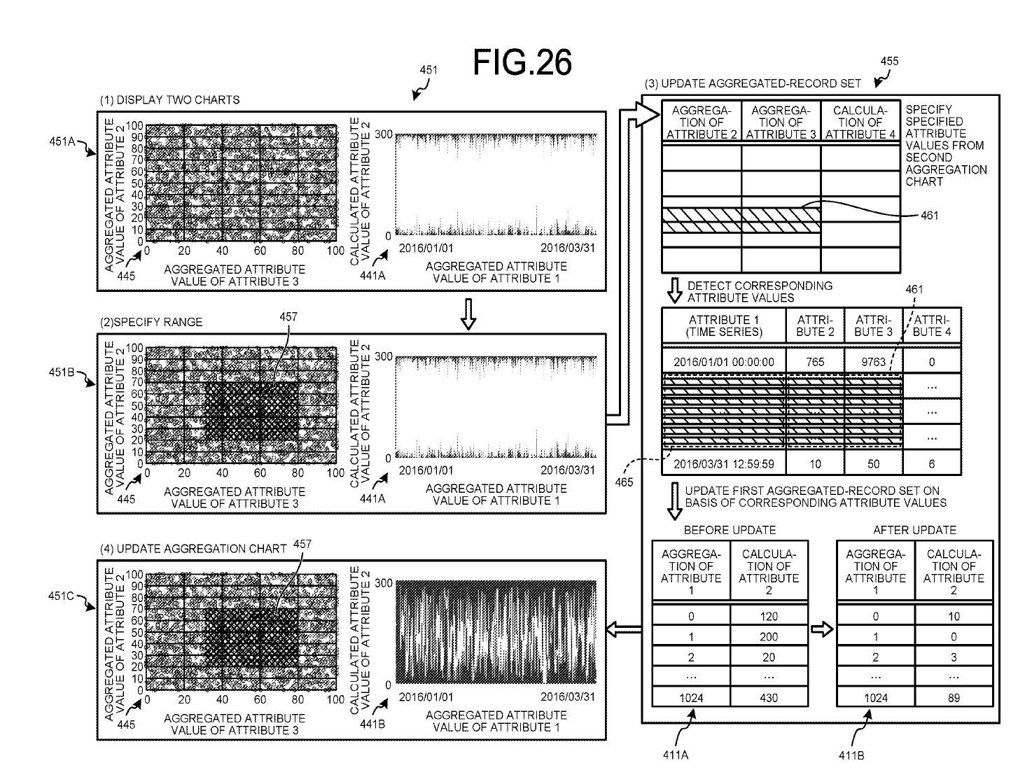

FIG. 26 is a diagram illustrating an example of a display image 451, and update processing 455 updating the display image 451, according to a fourth example of the third embodiment. In the present example, a second aggregation chart 445 is used as the user interface for inputting a filtering condition, and a first aggregation chart 441A is updated on the basis of the filtering condition. FIG. 26 illustrates a first display image 451A, a second display image 451B, and a third display image 451C.

The first display image 451A illustrates a state before inputting a filtering condition for filtering information displayed on the first aggregation chart 441A.

The second display image 451B illustrates a state after inputting the filtering condition. In the present example, a desired specification range 457 in the second aggregation chart 445 is specified, and partial attribute values belonging to the attribute 2 and the attribute 3 are specified.

The update processing 455 represents an example of internal processing updating the first aggregated-record set 411A from which the first aggregation chart 441A is generated, on the basis of the filtering condition specified in the second display image 451B. Firstly, from a specification result in the second display image 451B, partial specified attribute values 461 belonging to the attributes 2 and 3 are identified. Secondly, corresponding attribute values 465 are detected from the record set 401. Then, on the basis of the corresponding attribute values 465 and predetermined display area information, the first aggregated-record set 411A before update is updated to a first aggregated-record set 411B after update.

The third display image 451C illustrates a state after the first aggregation chart 441A is updated, and includes a first aggregation chart 441B after update which is generated on the basis of the first aggregated-record set 411B after update.

As described in the configurations illustrated in FIGS. 25 and 26, a plurality of aggregation charts may be displayed so that a filtering condition (specified attribute values) is specified through an aggregation chart to update another aggregation chart on the basis of the filtering condition.

While certain embodiments have been described, these embodiments have been presented by way of example only, and are not intended to limit the kinds of charts or the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display information generation system comprising circuitry configured to:
acquire a record set including a plurality of records respectively representing a correspondence relationship between a plurality of attribute values belonging to attributes different from each other;
acquire selected-attribute information identifying a plurality of selected attributes selected from the attributes;
acquire display area information about a display area;
on the basis of the selected-attribute information and the display area information, extract a plurality of selected attribute values belonging to the selected attributes from the record set, and generate an aggregated-record set including a plurality of aggregated attribute values into which the extracted selected attribute values are aggregated to fit in the display area; and from the aggregated record set
generate display information generating a display image including an aggregation chart representing the correspondence relationship between the selected attributes.

2. The display information generation system according to claim 1, wherein the circuitry is further configured to:
acquire specified-attribute value information identifying a plurality of specified attribute values specified from the attribute values included in the record set;
detect a plurality of corresponding attribute values as the selected attribute values included in the records including the specified attribute values; and
updates the aggregated-record set on the basis of the aggregated attribute values obtained by aggregating the corresponding attribute values to fit in the display area.

3. The display information generation system according to claim 2, wherein the circuitry is further configured to:
generate, on the basis of the selected-attribute information, an category-record set obtained by extracting the selected category attribute values belonging to the selected attributes from the record set;
generate the display information such that the display image further includes an extraction chart representing a correspondence relationship between the selected attribute values included in the category-record set;
select the specified-attribute value from the attribute values displayed on the extraction chart to acquire the specified-attribute value information; and
update the aggregated-record set of the aggregation chart on the basis of the specified-attribute value information acquired from the extraction chart.

4. The display information generation system according to claim 2, wherein the circuitry is further configured to:
generate the display information including multiple aggregation charts generated on the basis of the aggregated-record sets having respectively different combination of the selected attributes;
select the specified attribute values from the attribute values displayed on a first aggregation chart to acquire the specified-attribute value information; and
update the aggregated-record set of a second aggregation chart on the basis of the specified-attribute value information acquired from the first aggregation chart.

5. The display information generation system according to claim 1, wherein
the display area information includes the number of pixels of a display area in which the aggregation chart is displayed, and
the circuitry is further configured to adapt the number of the aggregated attribute values to the number of pixels.

6. The display information generation system according to claim 1, wherein the circuitry is further configured to control a display unit to display the display image on the basis of the display information.

7. The display information generation system according to claim 1, further comprising an information processing terminal, and a server connected to the information processing terminal through a network,
wherein the server is configured to perform at least one of generating the aggregated-record set or generating the display information, and
the information processing terminal includes the display unit.

8. A display information generation method comprising:
acquiring a record set including a plurality of records respectively representing a correspondence relationship between a plurality of attribute values belonging to attributes different from each other;
acquiring selected-attribute information identifying a plurality of selected attributes selected from the attributes;
acquiring display area information about a display area;
on the basis of the selected-attribute information and the display area information, extracting a plurality of selected attribute values belonging to the selected attributes from the record set, and generating an aggregated-record set including a plurality of aggregated attribute values into which the extracted selected attribute values are aggregated to fit in the display area; and from the aggregated record set
generating display information generating a display image including an aggregation chart representing the correspondence relationship between the selected attributes.

9. A computer program product having a non-transitory computer readable medium including programmed instructions for generating display information, wherein the instructions, when executed by a computer, cause the computer to perform:
acquiring a record set including a plurality of records respectively representing a correspondence relationship between a plurality of attribute values belonging to attributes different from each other;
acquiring selected-attribute information identifying a plurality of selected attributes selected from the attributes;
acquiring display area information about a display area;
on the basis of the selected-attribute information and the display area information, extracting a plurality of selected attribute values belonging to the selected attributes from the record set, and generating an aggregated-record set including a plurality of aggregated attribute values into which the extracted selected attribute values are aggregated to fit in the display area; and from the aggregated record set
generating the display information generating a display image including an aggregation chart representing the correspondence relationship between the selected attributes.
